(19) United States
(12) Patent Application Publication
(10) Pub. No.: US 2014/0349581 A1
(43) Pub. Date: Nov. 27, 2014

(54) APPARATUS AND METHOD FOR PARTIAL INTERFERENCE ALIGNMENT IN MULTI-ANTENNA COMMUNICATION SYSTEM

(71) Applicant: Electronics and Telecommunications Research Institute, Daejeon-si (KR)

(72) Inventors: Jinhyung OH, Daejeon (KR); Gwangzeen KO, Daejeon (KR); Igor KIM, Daejeon (KR); Myung Sun SONG, Daejeon (KR)

(21) Appl. No.: 13/946,195

(22) Filed: Jul. 19, 2013

(30) Foreign Application Priority Data
May 21, 2013 (KR) 10-2013-0057002

(51) Int. Cl. H04L 25/08

(52) U.S. Cl. CPC H04L 25/08
USPC 455/63.1

(57) ABSTRACT

A method for a partial interference alignment in a multi-antenna communication system includes, checking the number of access points (APs) operating at the same channel or adjacent channel; and calculating LIPs (Leakage Interference Power) that the respective APs have an effect on each base-station (STA). Further, the method includes choosing the upper three AP-STA pairs having the highest LIP in order as a candidate group for interference alignment; and performing a partial interference alignment on the candidate group for interference alignment.

### CROSS-REFERENCE TO RELATED APPLICATION(S)

The present invention claims priority of Korean Patent Application No. 10-2013-0057002, filed on May 21, 2013, which is incorporated herein by reference.

### FIELD OF THE INVENTION

The present invention relates to an interference alignment technology between networks with a MIMO (Multi Input and Multi Output) technique that are composed of a plurality of base station-terminal pairs. More particularly, the present invention relates to an apparatus and method for a partial interference alignment in a multi-antenna communication network, which is capable of determining a candidate group to be subjected to an interference alignment in consideration of real-time interference channel information, path loss, ACI (Adjacent Channel Interference) and transmitting/receiving signals by performing a precoding that minimizes the interferences on the nodes that are not selected as the candidate group and the nodes that are subjected to the interference alignment in a case where the number of antennas are required more than necessary for aligning a number of interference sources under a channel environment where there are a plurality of AP (Access Point)-STA (base-STAtion) pairs, thereby reducing an effect due to the interference between the networks.

### BACKGROUND OF THE INVENTION

Recently, as smart devices increase in use and the amount of data requested by the respective smart devices increase, a number of APs (Access Points) to support the amount of data are installed in a wireless LAN Local Area Network) like so many mushrooms. As a result, signal interferences between adjacent cells increase, which in turn leads to the degradation of the overall system performance.

There is an interference alignment technology as one of the solutions to solve the interference problem. The interference alignment technology refers to a technique that arranges interference signals in specific resources (e.g., time, space and frequency) to secure maximum resources through which a desired signal can be sent.

For example, in a case where an interference alignment is performed by using multiple antennas in a wireless LAN environment, an STA that receives signals aligns interference signals that arrive from other APs to a specific spatial resource, so that a space through which desired signals are transmitted to facilitate the separation of the interference signals from the desired signal.

The interference alignment technology enables the users in the interference channel environment to use DoF (Degrees of Freedom) up to half the maximum resources of the antenna. The term “DoF” used herein refers to the maximum number of streams that can transmit signals without interference. As such, the interference alignment technology has attracted attention in terms of solving the problem of interference between adjacent cells. However, interference alignment technology has a disadvantage in that an undue computational complexity is required for calculating precoding/decoding matrixes, which are used in modulation and demodulation stages to perform the interference alignment, and each node should know a large amount of radio channel condition information. Further, the number of the antennas needs to increase in proportion to the number of interference sources in order to make the aligned interference null.

Meanwhile, in order to apply an interference alignment algorithm to an existing communication system, it is important to solve issues of the complexity of the calculations, computation time of the interference alignment precoding/decoding matrix and channel feedback. In order to satisfy the first two requirements, it is necessary to arrange the interference with a linear method. The term “linear method” used herein means to apply precoding/decoding matrix for the interference alignment to signals by performing a one-step procedure in any component in each node. In an opposite sense, there is an iterative method, but this method is to seek a solution by repeating a loop until a weight of the interference alignment is satisfied to a certain condition. However, when applying this method, since it takes a long calculation time and incurs a computational complexity, there is a problem in applying it to the existing system.

As such, the linear interference alignment algorithm has a minimum condition for application to the existing system. However, the linear interference alignment algorithm has been utilized in an environment where three users or fewer exist only to date. It is needed an interference alignment algorithm in an environment where a K-number of users are present because a basic communication system considers an environment in which the K-number of users is present.

Further, there are researches that the more the number of users increases in an environment where a K-number of users are present, the more the number of antennas for the interference alignment needs also to increase. It can be known from these findings that the alignment of the interference of all users is a burden to the system due to the increase in a computational complexity and the number of antennas. In the actual communication environment, considering real-time interference channel information between each AP and STA, path loss, ACI (Adjacent Channel Interference), there may be nodes even without aligning the interference.

In such a case, judging from the viewpoint of the entire system, it will also possible to render as interference while applying the interference alignment technology to rest nodes except the nodes without aligning the interference. Then, if the channels are primarily different, there may be no interference with each other, but there is a leakage to neighboring channels, which causes the interference. If the leakage is larger, this situation also needs the interference alignment technology. However, if the leakage is not higher than necessary, there may be nodes that may be excluded from the candidate group for interference alignment as in the previous case. Accordingly, it is strongly necessary to determine which node is necessary to perform the interference alignment while reflecting realistic conditions such as the path loss, ACI, and real-time interference channel information.

### SUMMARY OF THE INVENTION

In view of the above, the present invention provides an apparatus and method for a partial interference alignment in a multi-antenna communication network, which is capable of determining a candidate group to be subjected to an interference alignment in consideration of real-time interference channel information, path loss, ACI (Adjacent Channel Interference) and transmitting/receiving signals by performing a precoding that minimizes the interferences on the nodes that are not selected as the candidate group and the nodes that are subjected to the interference alignment in a case where the number of antennas are required more than necessary for aligning a number of interference sources under a channel environment where there exist a plurality of AP-STA pairs, thereby reducing an effect due to the interference between the networks.

In accordance with a first aspect of the present invention, there is provided a method for a partial interference alignment in a multi-antenna communication system. The method includes checking the number of access points (APs) operating at the same channel or adjacent channel; calculating LIPs (Leakage Interference Power) that the respective APs have an effect on each base-station (STA); choosing the upper three AP-STA pairs having the highest LIP in order as an candidate group for interference alignment; and performing a partial interference alignment on the candidate group for interference alignment.

Further, the performing a partial interference alignment may comprise performing an interference alignment precoding on the APs that belong to the candidate group for interference alignment; and performing a precoding on APs that do not belong to the candidate group for interference alignment so that their SLNRs (Signal Leakage Noise Ratio) are maximized.

Further, the calculating an LIP (Leakage Interference Power) may comprise calculating the LIP in consideration of a value of real-time interference channels, a path loss, and an adjacent channel interference.

Further, in the calculating an LIP, the path loss may be calculated to be in proportion to a distance between the STA and the respective APs.

Further, the LIP may be in inverse proportion to the path loss.

Further, the performing a partial interference alignment may comprise calculating a null space in consideration of interference spaces aligned with respect to the upper three AP-STA pairs having the highest LIP in order.

In accordance with a second aspect of the present invention, there is provided an apparatus for a partial interference alignment in a multi-antenna communication system. The apparatus may comprise an AP (Access Point) detection unit configured to check the number of APs operating on the same channel or adjacent channel; an interference calculation unit configured to calculate LIPs (Leakage Interference Power) that the respective APs have an effect on each base-station (STA); and an interference alignment unit configured to choose the upper three AP-STA pairs having the highest LIP in order among from the LIPs calculated by the interference calculation unit as a candidate group for interference alignment, perform an interference alignment precoding on the APs that belong to the candidate group for interference alignment, and perform a precoding on the APs that do not belong to the candidate group for interference alignment so that their SLNRs (Signal Leakage Noise Ratio) are maximized.

Further, the interference calculation unit may be configured to calculate the LIPs in consideration of a value of real-time interference channels, a path loss, and an adjacent channel interference.

Further, the interference calculation unit may be configured to calculate the path loss so that the path loss is in proportion to a distance between the STA and the respective APs.

Further, the LIP may be in inverse proportion to the path loss.

Further, the interference alignment unit may be configured to calculate a null space in consideration of aligned interference spaces with respect to the three AP-STA pairs having the highest LIP in order.

In accordance with an embodiment of the present invention, it is possible to reduce an effect due to the interference between the networks when performing a partial interference alignment in a multi-antenna communication network, by determining a candidate group to be subjected to an interference alignment in consideration of real-time interference channel information, path loss, ACI (Adjacent Channel Interference) and performing a precoding that minimizes the interferences on the nodes that are not selected as the candidate group and the nodes that are subjected to the interference alignment to transmit/receive signals in a case where the number of antennas are required more than necessary for aligning a number of interference sources under a channel environment where there exist a plurality of AP-STA pairs.

Further, in choosing the AP-STA pairs which will be subjected to the interference alignment, the embodiment proposes a measurement criterion of an LIP (Leakage Interference Power) in consideration of real-time interference channel information, path loss and ACI (Adjacent Channel Interference), selects three AP-STA pairs having the highest LIP in order in conformity with the measurement criterion as a candidate group for the interference alignment, and performs a precoding on the remaining pairs for the transmission so that SLNRs become maximum, thereby achieving an optimal performance.

### BRIEF DESCRIPTION OF THE DRAWINGS

The above and other objects and features of the present invention will become apparent from the following description of the embodiments given in conjunction with the accompanying drawings, in which:

FIG. 1 shows an illustrative view of interference channels of a K-number of users with a multi-antenna in a wireless environment in accordance with a prior art;

FIG. 2 shows a detailed block diagram of a partial interference alignment apparatus used in a communication system with a multi-antenna in accordance with an embodiment of the present invention;

FIG. 3 is a control flow diagram illustrating a partial interference alignment method in accordance with an embodiment of the present invention; and

FIG. 4 shows an illustrative view a procedure of calculating an SLNR (Signal Leakage Noise Ratio) in interference channels of a K-number of users with a multi-antenna.

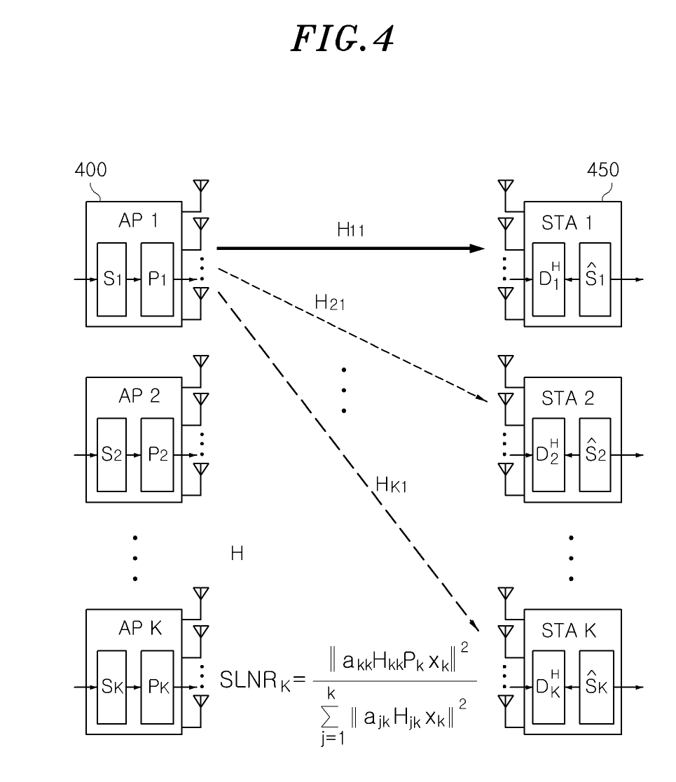

### DETAILED DESCRIPTION OF THE EMBODIMENTS

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms need to define throughout the description of the present invention.

Hereinafter, the embodiments of the present invention will be described in detail with reference to the accompanying drawings.

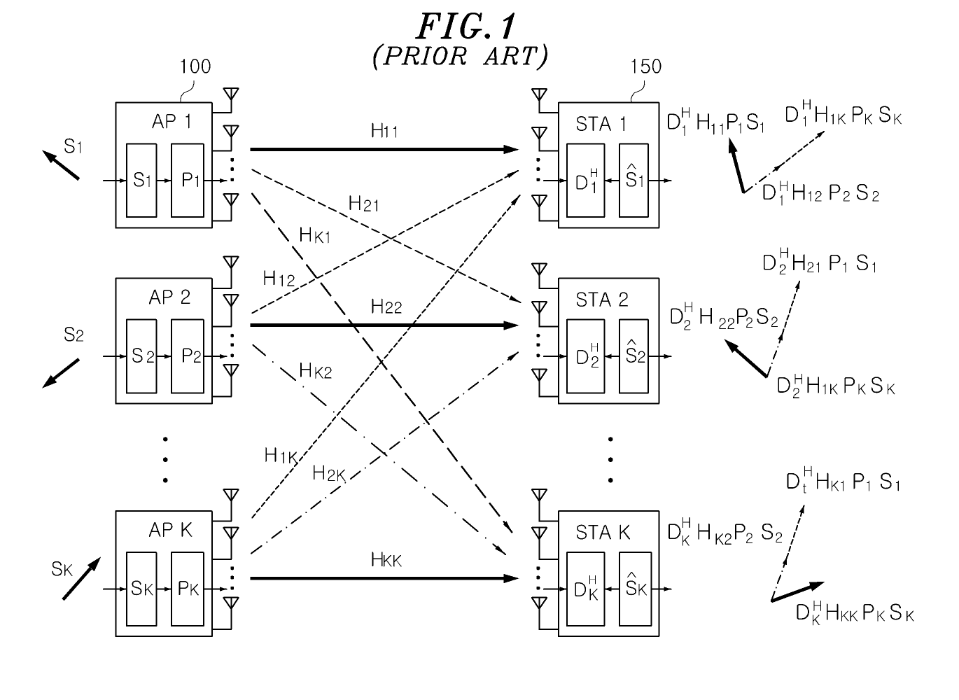

FIG. 1 shows an illustrative view of interference channels of a K-number of users with a multi-antenna in a wireless environment in accordance with a prior art, which illustrates a situation where a plurality of stations (STAs) 150 having a multi-antenna shares the same channel with a plurality of access points (APs) to communicate with each other through the channel.

Referring to FIG. 1, it can be known that other APs have an effect on other STAs 100. It is assumed that each AP has an M-number of antennas and each STA has an N-number of antennas. A channel that an j-th AP access an i-th STA is called to a channel Hᵢⱼ. Consequently, a signal that the i-th STA receives from j-th may be expressed as a following Equation 1.

$${y}_{i} = {H}_{ii} {x}_{i} + {\sum }_{j = 1 , j \neq i}^{K} {H}_{ij} {x}_{j} + {n}_{i} \qquad Eq . 1$$

where Hᵢᵢxᵢ denotes a signal passing through a channel from an AP of the STA;

$${\sum }_{j = 1 , j \neq i}^{K} {H}_{ij} {x}_{j}$$

denotes a signal introduced through an interference channel from other APs; and nᵢ represents a noise in a receiving end.

In addition, xᵢ in Equation 1 is a signal that has been precoded at a transmission end and can be expressed by Equations 2-1 and 2-2.

xᵢ=Pᵢsᵢ Eq. 2-1

xⱼ=Pⱼsⱼ Eq. 2-2

where Pᵢ and sᵢ represent a precoding matrix (M×d) for an i-th user and a signal to be transmitted. Further, Pⱼ and sⱼ represent a precoding matrix (M×d) for an j-th user. The Equations 2-1 and 2-2 are substituted into the Equation 1, which yields a following Equation 3. In the above precoding matrix, and d denotes the number of streams that a transmitter wants to send.

$${y}_{i} = {H}_{ii} {P}_{i} {s}_{i} + {\sum }_{j = 1 , j \neq i}^{K} {H}_{ij} {P}_{j} {s}_{j} + {n}_{i} \qquad Eq . 3$$

The Equation 3 represents a type of signal before being subjected to a decoding process at a receiving end in the STA. A signal after passing through a decoding matrix at the receiving end can be expressed by a following Equation 4.

$${D}_{i}^{H} {y}_{i} = {D}_{i}^{H} {H}_{ii} {P}_{i} {s}_{i} + {\sum }_{j = 1 , j \neq i}^{K} {D}_{i}^{H} {H}_{ij} {P}_{j} {s}_{j} + {D}_{i}^{H} {n}_{i} \qquad Eq . 4$$

where a decoding matrix Dᵢ means a matrix with a size N×d for processing at a receiving end. In addition, nᵢ that exists at the last term in the Equation 4 means an AWGN (Additive White Gaussian Noise) vector that has a mean of 0 (zero) and dispersion of σ² where σ² denotes a power of noise.

Accordingly, a receiving SINR (Signal Leakage Noise

Ratio) of an i-th receiver to which the Equation 4 is reflected can be expressed by a following Equation 5.

$$\frac{{‖ {D}_{i}^{H} {H}_{ii} {P}_{i} {s}_{i} ‖}^{2}}{{\sum }_{j = 1 , j \neq i}^{K} {‖ {D}_{i}^{H} {H}_{ij} {P}_{j} {s}_{j} ‖}^{2} + {σ}_{i}^{2}} \qquad Eq . 5$$

The number of interferences having an effect on the respective receiving STAs is the number of K-1 in an interference channel environment having the K-number of AP-STA pairs. In order to align the K-1 number of interferences for each node, a condition such as a following Equation 6 need to be satisfied.

For example, a description will be made on a presumption of an interference channel environment having four users for the sake of convenience of explanation as follows. However, the presumption may be formalized in an environment in which even though the number of the users increases, the number of antennas and a surrounding condition are sufficiently ensured accordingly.

r₁=H₁₂P₂=H₁₃P₃=H₁₄P₄

r₂=H₂₁P₁=H₂₃P₃=H₂₄P₄ Eq. 6

r₃=H₃₁P₁=H₃₂P₂=H₃₄P₄

r₄=H₄₁P₁=H₄₂P₂=H₄₃P₃

The Equation 6 represents a condition to align the interferences that are entering the respective STAs in one space. In the Equation 6, a first equation may be an equation representing a condition to align three interferences entering a first STA in a space r₁. Remaining three equations may also be equations representing conditions to align three interferences entering their relevant STAs in the respective spaces. In order to obtain the precoding matrix P, the first equation is separated from the Equation 6 and then is arranged as in a following Equation 7.

r₁−H₁₂P₂=0

r₁−H₁₃P₃=0 Eq. 7

r₁−H₁₄P₄=0

After a second to fourth equations remaining in the Equation 6 have solved wholly as in the Equation 7, which can be represented in a matrix form that is expressed by a following Equation 8.

$$[ A ] [ B ] = 0 \\ where , \\ [ A ] = [ \begin{matrix}{I}_{{N}_{r} \times {N}_{t}} & {O}_{{N}_{r} \times {N}_{t}} & … & {H}_{ji} & … \\ ⋮ & ⋮ & ⋱ & & \\ {O}_{{N}_{r} \times {N}_{t}} & {I}_{{N}_{r} \times {N}_{t}} & … & {H}_{ji} & … \\ ⋮ & & & & \\ {O}_{{N}_{r} \times {N}_{t}} & … & {I}_{{N}_{r} \times {N}_{t}} & … & {H}_{ji} \\ ⋮ & & & & \\ {O}_{{N}_{r} \times {N}_{t}} & … & {O}_{{N}_{r} \times {N}_{t}} & {I}_{{N}_{r} \times {N}_{t}} & {H}_{ji} \\ ⋮ & & … & & ⋮\end{matrix} ] , \\ [ B ] = [ \begin{matrix}{r}_{1} \\ ⋮ \\ {r}_{K} \\ {P}_{1} \\ ⋮ \\ {P}_{K}\end{matrix} ] \qquad Eq . 8$$

That two matrixes [A] and [B] in the Equation 8 are multiplied to become a null matrix means that a matrix [B] should be configured to a null space of a matrix [A]. In the Equation 8, I_{N}_{ᵣ}×Nₜ denotes an identity matrix having a size of Nᵣ×Nₜ, and O_{N}_{ᵣ}×Nₜ denotes a zero matrix having a size of Nᵣ×Nₜ. The magnitude of the matrix [A] in the Equation 8 is represented by a following Equation 9.

(nᵣ×K(K−1))×(N ₜ×(K+# of interference aligned space)) Eq. 9

A “# of interference aligned space” in the Equation 9 means the number of specific spaces r₁˜r₄ where the respective interferences are aligned.

As an example, the number of the interference aligned spaces is four (4) of the Equation 6. However, if the matrix [B] is made to be a null space of the matrix [A], the number of columns needs to be more than that of lows by a desired number of DoF. That is, all the interferences can be aligned when a condition as expressed in a following Equation 10 should be satisfied.

(Nᵣ×(# of total Tx−Rx pairs+# of interference aligned space))−(Nᵣ×# of total interference suffering channel)≧DoF Eq. 10

As known from the Equation 10, as the number of nodes APs and STAs increase, the number of receiving antennas should increase, as expressed at the tail of the Equation 10, (the reason to increase the number of the receiving antennas intends to increase the interference aligned spaces for individual STA) or the number of the transmission antennas and the number of the interference aligned spaces should increase, as expressed at the head of the Equation 10. However, since the interference aligned spaces are related to the number of receiving antennas and overall nodes and the number of the overall interference channels is also related to the number of nodes, as the number of AP-STA pairs increase, the number of the transmission antennas to satisfy the Equation 10 is put to increase.

As a result, the number of AP-STA pairs that interfere with each other also increases excessively, and thus aligning all the interference becomes extremely complex in practice.

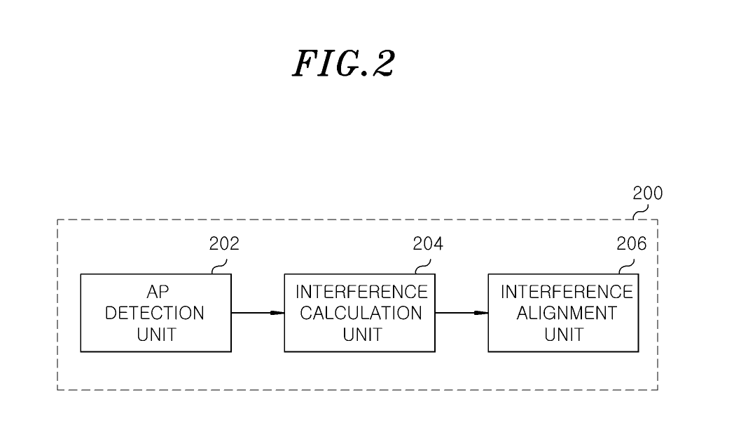

FIG. 2 shows a detailed block diagram of a partial interference alignment apparatus used in a communication system with a multi-antenna in accordance with an embodiment of the present invention. A partial interference alignment apparatus 200 of the embodiment includes an AP detection unit 202, an interference calculation unit 204 and an interference alignment unit 206.

In accordance with the embodiment of the present invention, the partial interference alignment apparatus 200 may be implemented in an AP side in software or firmware so that it can cope with a downlink situation.

Hereinafter, the operation of the respective components of the partial interference alignment apparatus will be described in detail as follows.

First, the AP detection unit 202 checks the number of APs that are operated in the same channel or neighboring channel.

The interference calculation unit 204 calculates LIPs (Leakage Interference Power) that the respective APs, which are detected by the AP detection unit 202, have an effect on each STA. The LIPs in the interference calculation unit 204 may be calculated in consideration of a value of real-time interference channels, path loss, or adjacent channel interference.

The interference alignment unit 206 selects the upper three AP-STA pairs having the highest LIPs in order to set them as a member of a candidate group for interference alignment with reference to the LIPs calculated by the interference calculation unit 204. The interference alignment unit 206 also performs an interference alignment precoding on the APs that belongs to the candidate group for interference alignment and performs a precoding on the APs that do not belong to the candidate group for interference alignment so that their SLNRs (Signal Leakage Noise Ratio) have a maximum value.

Further, the interference alignment unit 206 calculates null spaces in consideration of the aligned interference spaces of the upper three AP-STA pairs having the highest LIPs.

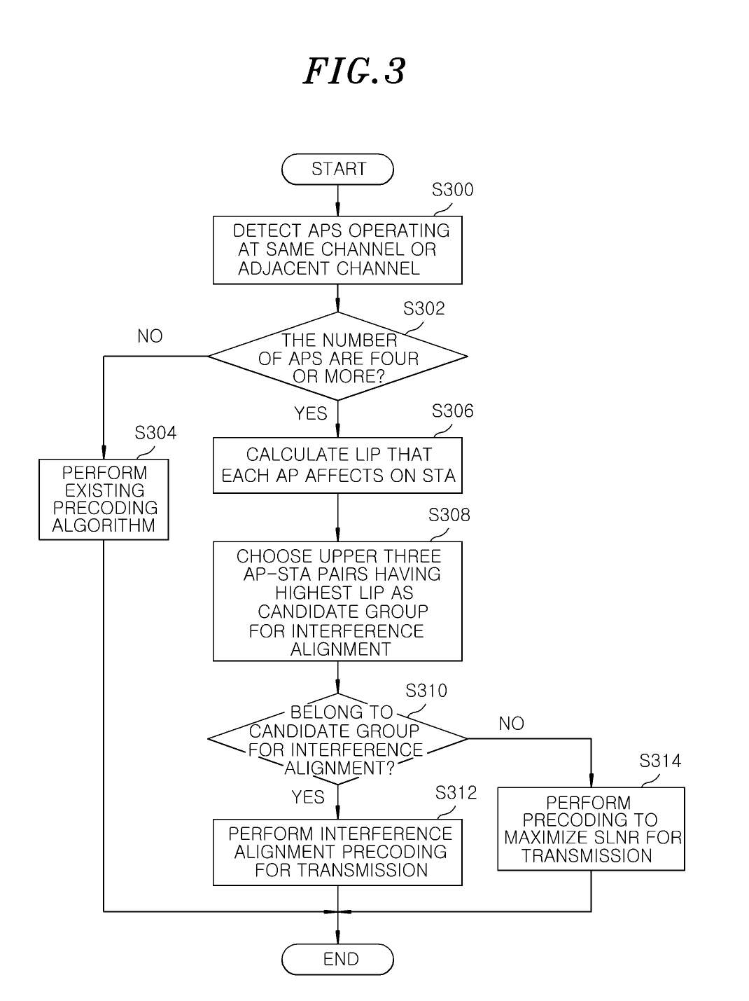

A partial interference alignment method performed by the interference alignment unit 206 will be described with reference to a control flow diagram for the partial interference alignment illustrated in FIG. 3.

FIG. 3 illustrates a control flow diagram for reducing interference influenceusing a partial interference alignment apparatus in a communication network with multi-antenna in accordance with an embodiment of the present invention. The embodiment of the present invention will be explained in detail with reference to FIGS. 2 and 3.

In a case where there are many AP-STA pairs that have a possibility to interfere with each other, the embodiment of the present invention proposes a partial reference alignment method to achieve a reference alignment by confining targets to be subjected to the reference alignment in order not to increase the complexity further.

The term “partial reference alignment” used herein refers to a scheme for transmitting signals that selects nodes that have a capability of perfectly aligning the references to perform the interference alignment and performs a precoding that makes the SLNRs maximum on remaining nodes that are excluded from the reference alignment candidate group in conformity with a specific condition.

On the other hand, the more the number of APs increases, the more the number of interference sources that have an effect on a receiving STA also increases, but it is complex to align all the interferences due to the facts as described as set forth above. Consequently, the embodiment of the present invention partially aligns a portion of the interferences while exempting the APs that do not have serious interferences.

First, in an operation S300, the AP detection unit 202 detects APs that operate on the same channel or an adjacent channel to calculate the number of the APs.

When the APs are detected by the AP detection unit 202, the interference calculation unit 204 checks whether the number of the APs is four or more by counting the number of the APs, in operation S302. When it is checked that the number of the APs is less than four, the interference calculation unit 204 does not calculate the LIPs for the APs and allows the APs to pass through an existing algorithm that makes the SLNRs maximum, in operation S304. However, when it is checked that the number of the APs is four or more, the interference calculation unit 204 calculates the LIPs that the detected APs have an effect on each STA, in operation S306.

In this regard, the LIPs may be determined in consideration of a value of real-time interference channels, a path loss, and an adjacent channel interference.

The value of real-time interference channels is a value (information) of real-time interference channels of a Rayleigh fading in view of a small scale fading.

The LIP of an AP that has a far distance among between AP-STA pairs may be calculated with a low value in consideration of a path loss.

In addition, the strength of an output power needs to be calculated in consideration of the adjacent channel interferences as follows.

An existing channel alignment algorithm acts on only the channels occurring a co-channel interference (CCI), and although a wireless LAN operating at 2.4GHz of an unlicensed band has 13 channels, only four channels among them, Nos. 1, 5, 9 and 13, are not overlapping in bandwidth. Thus, a user who uses No. 1 channel may suffer adjacent channel interferences with other users who use Nos. 2, 3 and 4 channels. As such, in a case where an adjacent AP uses another channel, the adjacent channel interferences may come over the user's channel. In this situation, it is regarded that the adjacent AP uses a low transmission power, and the adjacent AP using the adjacent channel should be also included in selecting the candidate group to which the interference channel alignment will be tried. However, since the strength of the output power is insufficient to interfere, the probability that the adjacent AP is selected as a one node of the candidate group for interference alignment may be significantly low. Therefore, the embodiment of the present invention determines the candidate group to pass through the interference alignment in consideration of even the above requirement.

Therefore, putting an LIP (Leakage Interference Power) in a formula, in consideration of the three factors as set for the above, it can be expressed by the Equation 11 as below.

LIP=Pᵢ·∥aᵢⱼ∥²·∥Hᵢⱼ∥²,

where aᵢⱼ=\sqrt{βdⱼᵢ^{-α}10^{ξ/10}} Eq. 11

where aᵢⱼ denotes a Large scale fading, β adenotes a path loss constant, α denotes a path loss exponent, dⱼᵢ denotes a distance between an AP and an STA, ξ means a log-normal shadowing having a distribution of N (0 dB, 8 dB), Pᵢ means a transmission power to transmit at an i-th access point i-th access point Apᵢ, and Hᵢⱼ means a Rayleigh fading channel value from a j-th transmitter to an i-th receiver.

In operation S308, the interference alignment unit 206 selects the upper three AP-STA pairs as the candidate group for interference alignment with reference to the LIPs calculated from the interference calculation unit 204. That is, the interference alignment unit 206 selects the candidates to be subjected to the interference alignment in order of the highest LIPs using the LIPs that each AP influences the respective STAs when choosing the candidate APs which will be subjected to the interference alignment among from a plurality of APs.

Next, the interference alignment unit 206 checks whether which AP belongs to the candidate group for interference alignment with respect to all the APs, in an operation S310; performs an interference alignment precoding with respect to the APs that belong to the candidate group for interference alignment, in an operation S312; and performs a precoding with respect to the APs that do not belong to the candidate group for interference alignment so that their SLNRs become a maximum value, in an operation S314.

In other words, the interference alignment unit 206 selects three AP-STA pairs having the highest LIP in order, which is obtained using the Equation 11, among from the K-number of AP-STA pairs, to perform the precoding on the three AP-STA pairs and performs a precoding on the transmitters in a remaining (K-3)-number of AP-STA pairs except the three AP-STA pairs such that their SLNRs become a maximum value.

Herein, the term “SLNR” means a ratio of an amount of interference that a transmitter itself influences other receiving STA through an interference channel to a signal strength of the transmitter. Therefore, if the signal strength of its own maximizes while minimizing the amount of interference that itself influence the other STA, it may be possible to minimize to some extent degradation of performance occurring since the other receiver does not null the interference due to the lack of the number of antennas.

In a receiving STA, all the receivers (inclusive of the receivers to perform the interference alignment) perform a Zero-Forcing as a decoding method. In a case where all interferences are aligned, each receiver obtains a null space of one aligned interference space. Meanwhile, in a case where the partial interference alignment is performed, each receiver that participates in the interference alignment obtains a null space in consideration of interference spaces aligned with respect to the three AP-STA pairs having the highest LIP in order.

Further, the STAs that do not participate in the interference alignment obtain null spaces of interference spaces from all the APs exclusive of the APs that belong to them in order to utilize a receiving decoding matrix.

An important consideration in this situation is that a receiver is able to obtain the null space for the interference spaces only when the number of the receiving antennas should be over a value obtained by multiplying a value of the number of entire interference sources plus one by the number of streams that the receiver itself will receive, which can be expressed in a following the Equation 12.

Nᵣ≧(1+the number of interference sources) x the number of streams to be transmitted by a transmitter Eq. 12

If the condition of the Equation 12 is not satisfied since there are many numbers of streams to be transmitted by the AP (i.e., the transmitter) or there are few numbers of antennas in a receiving STA, it may be possible to use a matched filter to maximize the signal of the transmitter itself rather than to consider the interferences.

As described above, in accordance with an embodiment of the present invention, when performing a partial interference alignment in a multi-antenna communication system, in a case where the number of antennas is required more than necessary in a channel environment having a plurality of AP-STA pairs, the interference effect between AP-SAT networks can be reduced by selecting a candidate group to be subjected to the interference alignment in consideration of real-time interference channel information, path loss and ACI (Adjacent Channel Interference), and performing a precoding that is capable of minimizing the interferences on the selected candidate group.

While the invention has been shown and described with respect to the embodiments, the present invention is not limited thereto. It will be understood by those skilled in the art that various changes and modifications may be made without departing from the scope of the invention as defined in the following claims.

What is claimed is:

1. A method for a partial interference alignment in a multi-antenna communication system, the method comprising:
checking the number of access points (APs) operating at the same channel or adjacent channel;
calculating LIPs (Leakage Interference Power) that the respective APs have an effect on each base-station (STA);
choosing the upper three AP-STA pairs having the highest LIP in order as an candidate group for interference alignment; and
performing a partial interference alignment on the candidate group for interference alignment.

2. The method of claim 1, wherein said performing a partial interference alignment comprises:
performing an interference alignment precoding on the APs that belong to the candidate group for interference alignment; and
performing a precoding on APs that do not belong to the candidate group for interference alignment so that their SLNRs (Signal Leakage Noise Ratio) are maximized.

3. The method of claim 1, wherein said calculating an LIP (Leakage Interference Power) comprises:
calculating the LIP in consideration of a value of real-time interference channels, a path loss, and an adjacent channel interference.

4. The method of claim 3, wherein in said calculating an LIP, the path loss is calculated to be in proportion to a distance between the STA and the respective APs.

5. The method of claim 4, wherein the LIP is in inverse proportion to the path loss.

6. The method of claim 1, wherein said performing a partial interference alignment comprises:
calculating a null space in consideration of interference spaces aligned with respect to the upper three AP-STA pairs having the highest LIP in order.

7. An apparatus for a partial interference alignment in a multi-antenna communication system, the apparatus comprising:
an AP (Access Point) detection unit configured to check the number of APs operating on the same channel or adjacent channel;
an interference calculation unit configured to calculate LIPs (Leakage Interference Power) that the respective APs have an effect on each base-station (STA); and
an interference alignment unit configured to choose the upper three AP-STA pairs having the highest LIP in order among from the LIPs calculated by the interference calculation unit as a candidate group for interference alignment, perform an interference alignment precoding on the APs that belong to the candidate group for interference alignment, and perform a precoding on the APs that do not belong to the candidate group for interference alignment so that their SLNRs (Signal Leakage Noise Ratio) are maximized.

8. The apparatus of claim 7, wherein the interference calculation unit is configured to calculate the LIPs in consideration of a value of real-time interference channels, a path loss, and an adjacent channel interference.

9. The apparatus of claim 8, wherein the interference calculation unit is configured to calculate the path loss so that the path loss is in proportion to a distance between the STA and the respective APs.

10. The apparatus of claim 9, wherein the LIP is in inverse proportion to the path loss.

11. The apparatus of claim 7, wherein the interference alignment unit is configured to calculate a null space in consideration of aligned interference spaces with respect to the three AP-STA pairs having the highest LIP in order.
